(19) United States
(12) Patent Application Publication
(10) Pub. No.: US 2026/0005713 A1
(43) Pub. Date: Jan. 1, 2026

(54) RADIO FREQUENCY DEVICES AND METHODS FOR MANUFACTURING THEREOF

(71) Applicant: Infineon Technologies AG, Neubiberg (DE)

(72) Inventors: Walter HARTNER, Bad Abbach (DE); Tuncay ERDÖL, Unterhaching (DE); Christian GEISSLER, Teugn (DE); Ernst SELER, München (DE)

(21) Appl. No.: 19/238,170

(22) Filed: Jun. 13, 2025

(30) Foreign Application Priority Data
Jun. 27, 2024 (DE) 102024206031.3

(51) Int. Cl. H04B 1/04; H04B 1/40

(52) U.S. Cl. CPC H04B 1/0483; H04B 1/40

(57) ABSTRACT

A radio frequency (RF) device includes a substrate; an RF chip arranged on a first main surface of the substrate; a first coupling element arranged in the substrate and configured to couple an RF signal into or out of the substrate; a second coupling element arranged in the substrate and configured to couple an RF signal into or out of the substrate; a first RF signal path coupling the RF chip and the first coupling element, wherein the first RF signal path is at least partially arranged in the substrate and includes a first section with an RF signal propagation parallel to the first main surface; and a second RF signal path coupling the RF chip and the second coupling element, the second RF signal path including a first section with an RF signal propagation parallel to the first main surface.

### CROSS-REFERENCE TO RELATED APPLICATION

This application claims priority to Germany Patent Application No. 102024206031.3 filed on Jun. 27, 2024, the content of which is incorporated by reference herein in its entirety.

### TECHNICAL FIELD

The present disclosure relates to radio frequency (RF) devices and methods for manufacturing RF devices.

### BACKGROUND

An integration of more and more radio frequency (RF) channels into RF devices (such as high resolution radar systems) may increase the size of associated integrated circuits and the package dimensions. In some cases, substrate integrated waveguides (SIWs) may be used as routing lines of the RF devices due to their robustness against manufacturing tolerances and low loss over longer distances. Since SIW lines may require a large amount of space, an increase in the number of RF channels may result in a significant increase of the package dimensions for routing the RF channels.

Manufacturers and developers of RF devices are constantly striving to improve their products. In the above context, it may be desirable to maintain or even reduce the size of RF devices despite an increase in the number of RF channels. In addition, it may be desirable to provide cost-efficient methods for manufacturing such RF devices.

### SUMMARY

An aspect of the present disclosure relates to a radio frequency (RF) device. The RF device includes a substrate and an RF chip arranged on a first main surface of the substrate. The RF device further includes a first coupling element arranged in the substrate and configured to couple an RF signal into or out of the substrate and a second coupling element arranged in the substrate and configured to couple an RF signal into or out of the substrate. The RF device further includes a first RF signal path coupling the RF chip and the first coupling element, wherein the first RF signal path is at least partially arranged in the substrate and includes a first section with an RF signal propagation parallel to the first main surface. The RF device further includes a second RF signal path coupling the RF chip and the second coupling element, the second RF signal path including a first section with an RF signal propagation parallel to the first main surface, wherein the first section of the first RF signal path and the first section of the second RF signal path are at least partially arranged on different levels with respect to a direction perpendicular to the first main surface of the substrate.

A further aspect of the present disclosure relates to a method for manufacturing an RF device. The method includes an act of generating a substrate including a first coupling element and a second coupling element arranged in the substrate, wherein each of the first coupling element and the second coupling element is configured to couple an RF signal into or out of the substrate. The method further includes an act of arranging an RF chip on a first main surface of the substrate. The method further includes an act of coupling the RF chip and the first coupling element via a first RF signal path, wherein the first RF signal path is at least partially arranged in the substrate and includes a first section with an RF signal propagation parallel to the first main surface. The method further includes an act of coupling the RF chip and the second coupling element via a second RF signal path, the second RF signal path including a first section with an RF signal propagation parallel to the first main surface, wherein the first section of the first RF signal path and the first section of the second RF signal path are arranged on different levels with respect to a direction perpendicular to the first main surface of the substrate.

### BRIEF DESCRIPTION OF THE DRAWINGS

Devices and methods in accordance with the disclosure are described in more detail below based on the drawings. The elements of the drawings are not necessarily to scale relative to each other. Similar reference numerals may designate corresponding similar parts. The technical features of the various illustrated examples may be combined unless they exclude each other and/or can be selectively omitted if not described to be necessarily required.

FIGS. 1A and 1B schematically illustrate a cross-sectional side view and a top view of an RF device 100 in accordance with the disclosure.

FIGS. 2A and 2B schematically illustrate a cross-sectional side view of an RF device 200 in accordance with the disclosure and a detail of the RF device 200.

FIGS. 3A and 3B schematically illustrate a cross-sectional side view and a top view of an RF device 300 in accordance with the disclosure.

FIGS. 4A and 4B schematically illustrate a cross-sectional side view and a top view of an RF device 400 in accordance with the disclosure.

FIG. 5 schematically illustrates a cross-sectional side view of an RF device 500 in accordance with the disclosure.

FIG. 6 illustrates a flowchart of a method for manufacturing an RF device in accordance with the disclosure.

### DETAILED DESCRIPTION

In the following detailed description, reference is made to the accompanying drawings, in which are shown by way of illustration specific aspects in which the disclosure may be practiced. In this regard, directional terminology, such as “top”, “bottom”, “front”, “back”, or the like may be used with reference to the orientation of the figures being described. Since components of described devices may be positioned in a number of different orientations, the directional terminology may be used for purposes of illustration and is in no way limiting. Other aspects may be utilized and structural or logical changes may be made without departing from the concept of the present disclosure. Hence, the following detailed description is not to be taken in a limiting sense, and the concept of the present disclosure is defined by the appended claims.

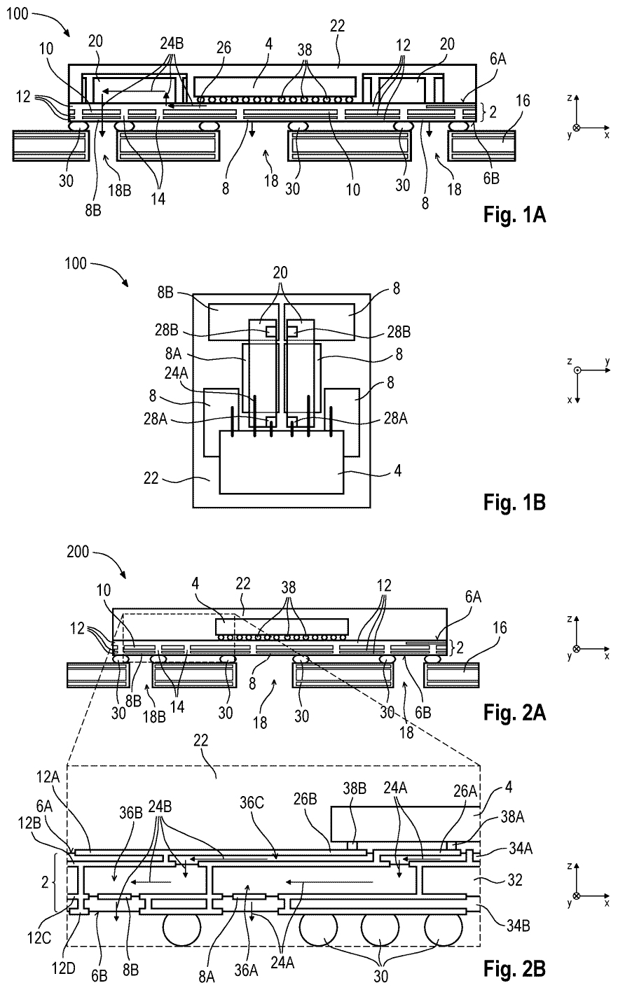

Referring now to FIGS. 1A and 1B, a radio frequency (RF) device 100 in accordance with the disclosure is shown. The RF device 100 may also be referred to as RF package. The RF device 100 may include a substrate 2 and an RF chip 4 arranged on a first main surface 6A of the substrate 2. The RF device 100 may further include at least two coupling elements 8A and 8B arranged in the substrate 2 and configured to couple RF signals into or out of the substrate 2. Note that the coupling element 8A is not shown in the cross-sectional side view of FIG. 1A due to the chosen perspective. In addition, the RF device 100 may include an arbitrary number of additional coupling elements 8. In this regard, the top view of FIG. 1B shows an example and non-limiting number of four additional coupling elements 8.

The substrate 2 may include a dielectric material 10 which may include or may be made of one or multiple dielectric glue layers. In addition, the substrate 2 may include multiple metal layers 12 which may be arranged on the first main surface 6A of the substrate 2, on a second main surface 6B of the substrate 2 opposite the first main surface 6A and/or in the dielectric material 10. Metal layers 12 arranged in the substrate 2 on different levels with respect to the z-direction may be electrically connected by via connections 14. Note that a more detailed example of a substrate 2 which may be included in an RF device in accordance with the disclosure is shown and described in connection with FIGS. 2A and 2B. The RF chip 4 may be electrically and mechanically coupled to the first main surface 6A of the substrate 2 by multiple electrical connection elements 38. In particular, the electrical connection elements 38 may provide an electrical connection between contacts of the RF chip 4 and one of the metal layers 12 arranged on the first main surface 6A of the substrate 2.

The RF chip 4 may be made of or may include an arbitrary semiconductor material, such as e.g., silicon. The RF chip 4 (or electronic circuits thereof) may be configured to operate in a frequency range of greater than about 1 GHz, in some examples greater than about 10 GHz. The RF chip 4 may thus also be referred to as radio frequency chip or high frequency chip or microwave frequency chip. More particular, the RF chip 4 may be configured to operate in an RF range or microwave frequency range, which may range from about 1 GHz to about 1 THz, more particular from about 10 GHz to about 300 GHz. Microwave circuits may include, for example, microwave transmitters, microwave receivers, microwave transceivers, microwave sensors, microwave detectors, or the like. RF devices in accordance with the disclosure may be used for radar applications in which the frequency of the RF signals may be modulated. The RF chip 4 may thus also be referred to as radar chip. In particular, the RF chip 4 may include or may correspond to an MMIC (Monolithic Microwave Integrated Circuit).

Radar microwave devices may e.g., be used in automotive, industrial, military and/or defense applications for range and speed measuring systems. For example, automotive applications may include advanced driver assistant systems, automatic vehicle cruise control systems, vehicle anti-collision systems, or the like. Such systems may operate in the microwave frequency range and may utilize FMCW (Frequency Modulation Continuous Wave) signals, for example in the 24 GHz, 76 GHz, or 79 GHz frequency bands. A use of radar microwave systems may provide constant and efficient driving of vehicles. An efficient driving style may, for example, reduce fuel consumption such that CO₂ emission may be reduced and energy savings may be enabled. In addition, abrasion of vehicle tires, brake discs and brake pads may be reduced, thereby reducing fine dust pollution. Improved RF or radar systems, as specified herein, may thus contribute to green technology solutions, e.g., climate-friendly solutions providing reduced energy usage.

Each of the coupling elements 8 may be configured to couple RF signals into or out of the substrate 2. Accordingly, the coupling elements 8 may also be referred to as transmission/reception elements. In some examples, the coupling elements 8 may include or may correspond to one or multiple antennas which may e.g., be formed in one or more of the metal layers 12. In the illustrated example, the coupling elements 8 may be arranged at the second main surface 6B of the substrate 2. In further examples, at least one of the coupling elements 8 may be arranged at a side surface of the substrate 2 and may be configured to transmit or receive RF signals in a substantially lateral direction.

The RF device 100 may be mounted on a printed circuit board (PCB) 16 which may be seen as a part of the RF device 100 or not. A mechanical and electrical connection between the substrate 2 and the PCB 16 may be established by multiple electrical connections elements 30, such as solder balls or solder depots. The PCB 16 may include multiple openings 18 aligned to the coupling elements 8 and extending through the PCB 16 in a substantially vertical direction. In some examples, the RF device 100 may include one or more waveguide antennas (not shown), wherein a respective coupling element 8 may be configured to couple RF signals via an aligned opening 18 to the respective waveguide antenna and/or vice versa. In this context, the RF device 100 may include an AFIP (Antenna Feed In Package), wherein the coupling elements 8 may correspond to launchers or launcher structures. Each launcher may be coupled to a respective RF port of the RF chip 4 to transfer an RF signal between the RF port and a waveguide antenna.

The RF device 100 may include at least one waveguide (or waveguide element) 20 arranged on the first main surface 6A of the substrate 2. In the illustrated example, the RF device 100 may include an example and non-limiting number of two waveguides 20 arranged adjacent to the RF chip 4. The waveguides 20 may be configured to transmit RF signals in a substantially lateral direction, e.g., in the x-y-plane. In one example, one or more of the waveguides 20 may be an air-filled waveguide. In a further example, one or more of the waveguides 20 may correspond to a substrate integrated waveguide (SIW) or SIW substrate element. In the latter case, a respective waveguide 20 may e.g., include two metal layers arranged over each other and substantially extending in the x-y-plane, a dielectric material arranged between the two metal layers and a plurality of via connections connecting the two metal layers.

The RF device 100 may include an encapsulation material 22 which may at least partially encapsulate components of the RF device 100. In the illustrated example, the encapsulation material 22 may be arranged on the first main surface 6A of the substrate 2 and may at least partially cover the waveguide(s) 20 and the RF chip 4. The encapsulation material 22 may include or may be made of at least one of an epoxy, a filled epoxy, a glass fiber filled epoxy, an imide, a thermoplast, a thermoset polymer, a polymer blend, a mold compound, or the like. Various techniques may be used for encapsulating components of the RF device 100 in the encapsulation material 22, for example at least one of compression molding, injection molding, powder molding, liquid molding, map molding, or the like.

The RF device 100 may include a first RF signal path 24A coupling the RF chip 4 and the first coupling element 8A. The first RF signal path 24A may be associated with a first RF channel of the RF chip 4. Note that the first RF signal path 24A is not shown in the cross-sectional side view of FIG. 1A due to the chosen perspective. The first RF signal path 24A may be at least partially arranged in the substrate 2 and may include a first section having an RF signal propagation parallel to the first main surface 6A of the substrate 2. In one example, the first section of the first signal path 24A may include or may correspond to an SIW arranged in the substrate 2. In this case, the SIW may include two of the metal layers 12 arranged at different levels of the substrate 2, the dielectric material 10 arranged between the two metal layers and multiple of the via connections 14 extending between the two metal layers. Note however that the first section of the first signal path 24A is not restricted to the example of an SIW. In a further example, the first section of the first signal path 24A may include or may correspond to a planar transmission line, such as a microstrip line, a coplanar waveguide, a ground-signal-ground line, or the like.

The RF device 100 may include a second RF signal path 24B coupling the RF chip 4 and the second coupling element 8B. The second RF signal path 24B may be associated with a second RF channel of the RF chip 4 different from the first RF channel associated with the first RF signal path 24A. In the illustrated example, the second RF signal path 24B may extend along four arrows indicating various sections of the second RF signal path 24B. In the shown case, the arrows may indicate a signal routing in a direction from the RF chip 4 to the second coupling element 8B. However, it is to be understood that a signal routing in the opposite direction may be established in a similar fashion. That is, in the example of FIGS. 1A and 1B (and also all further examples described herein) one-directional arrows may be replaced by bidirectional arrows.

The second RF signal path 24B may include a first section with an RF signal propagation parallel to the first main surface 6A of the substrate 2. In the illustrated example, the first section of the second RF signal path 24B may include the waveguide 20 arranged on the first main surface 6A of the substrate 2. In addition, the second RF signal path 24B may include a planar transmission line 26 at least partially arranged on the first main surface 6A of the substrate 2 and configured to couple the waveguide 20 and the RF chip 4. For example, the planar transmission line 26 may include or may correspond to at least one of a microstrip line, a coplanar waveguide, a ground-signal-ground line, or the like. A coupling element 28A may be configured to couple RF signals from the planar transmission line 26 into the waveguide 20 and/or vice versa. Such coupling between the planar transmission line 26 and the waveguide 20 is indicated by a vertical arrow pointing in an upward direction. In a similar fashion, a further coupling element 28B may be configured to couple RF signals from the waveguide 20 into the second coupling element 8B which is indicated by a vertical arrow pointing in a downward direction.

Since the first section of the first RF signal path 24A is at least partially arranged in the substrate 2 while the first section of the second RF signal path 24B at least partially extends in the waveguide 20 above the substrate 2, the two first sections may be at least partially arranged in the substrate 2 on different levels with respect to the z-direction. Due to such arrangement on different levels, the first section of the first RF signal path 24A and the first section of the second RF signal path 24B may at least partially overlap or cross each other when viewed in the z-direction. As can be seen from the example top view of FIG. 1B, the first sections of the RF signal paths 24A and 24B may overlap and may both extend e.g., in the x-direction.

The RF device 100 of FIGS. 1A and 1B may outperform other RF devices using a different RF signal routing. For example, another RF device may use SIWs for routing RF signals, wherein the SIWs may be arranged in the substrate 2 at a same level and thus cannot cross. In contrast to this, the RF device 100 provides the possibility of three-dimensional RF signal paths by routing the RF signals on different levels of the substrate 2, such that RF signal paths associated with different RF channels of the RF chip 4 may overlap and/or cross. As a result, and compared to other RF devices, the size of the RF device 100 can be reduced in the x-direction and/or the y-direction. In addition, the use of costly SIWs over the entire area of the substrate 2 can be avoided. Instead, SIWs only need to be used in areas where they are actually required.

The RF device 200 of FIGS. 2A and 2B may include some or all features of the RF device 100 of FIGS. 1A and 1B. FIG. 2A illustrates a cross-sectional side view of the RF device 200 while FIG. 2B particularly shows a detailed structure of a substrate 2 of the RF device 200. The substrate 2 may include a substrate core 32 and at least one prepreg layer 34 arranged on the substrate core 32. In the illustrated example, the substrate core 32 may be embedded between a first prepreg layer 34A arranged on the top surface of the substrate core 32 and a second prepreg layer 34B arranged on the bottom surface of the substrate core 32. Referring back to the example of FIGS. 1A and 1B, the substrate core 32 and the prepreg layers 34A, 34B of FIGS. 2A and 2B may correspond to the dielectric material 10 of FIGS. 1A and 1B. The substrate core 32 and the prepreg layers 34A, 34B may substantially extend in the x-y-plane. The substrate core 32 and the prepreg layers 34A, 34B may be made of a same material or may differ in their material composition. For example, each of the substrate core 32 and the prepreg layers 34A, 34B may be made of or may include one or multiple dielectric glue layers.

The substrate 2 may include a plurality of metal layers 12 that may be arranged on different levels with respect to the z-direction. In the illustrated example, the substrate 2 may include a first metal layer 12A arranged on the top surface of the first prepreg layer 34A, a second metal layer 12B arranged between the first prepreg layer 34A and the substrate core 32, a third metal layer 12C arranged between the substrate core 32 and the second prepreg layer 34B and a fourth metal layer 12D arranged on the bottom surface of the second prepreg layer 34B. Each of the metal layers 12A to 12D may be at least partially structured.

The RF device 200 may include a first SIW 36A arranged in the substrate core 32. The first SIW 36A may include the metal layers 12B and 12C as well as the substrate core 32 arranged between the metal layers 12B and 12C. In addition, the first SIW 36A may include a plurality of via connections extending between the metal layers 12B and 12C. The via connections may be arranged to form a via fence. The first SIW 36A may be formed by the substrate core 32 covered on both faces by the metal layers 12B and 12C. The substrate core 32 may embed the via connections that may form two parallel rows of metallic via holes delimiting a propagation area of RF signals (e.g., electromagnetic waves) that are to be transmitted via the first SIW 36A. The propagating electromagnetic waves may be confined within the substrate core 32 by the metal layers 12B and 12C on each of the two surfaces of the substrate core 32 as well as between the two rows of metallic vias connecting the metal layers 12B and 12C. In the illustrated example, the first SIW 36A may be configured to transmit electromagnetic waves in a lateral direction, e.g., in the x-y-plane.

The RF device 200 may include a second SIW 36B arranged in the substrate core 32 which may be configured similar to the first SIW 36A and include similar components as previously described. The second SIW 36B may be arranged laterally displaced to the first SIW 36A. In particular, the SIWs 36A and 36B may not necessarily overlap or cross when viewed in the z-direction.

The RF device 200 may include a third SIW 36C arranged in the first prepreg layer 34A. The third SIW 36C may include the metal layers 12A and 12B as well as the first prepreg layer 34A arranged between the metal layers 12A and 12B. In addition, the third SIW 36C may include a plurality of via connections extending between the metal layers 12A and 12B. The via connections may be arranged to form a via fence. The third SIW 36C may be formed by the first prepreg layer 34A covered on both faces by the metal layers 12A and 12B. The first prepreg layer 34A may embed the via connections that may form two parallel rows of metallic via holes delimiting a propagation area of RF signals that are to be transmitted via the third SIW 36C. The propagating electromagnetic waves may be confined within the first prepreg layer 34A by the metal layers 12A and 12B on each of the two surfaces of the first prepreg layer 34A as well as between the two rows of metallic vias connecting the metal layers 12A and 12B. In the illustrated example, the third SIW 36C may be configured to transmit electromagnetic waves in a lateral direction, e.g., in the x-y-plane.

The RF device 200 may include a first RF signal path 24A coupling the RF chip 4 (or more particular a first electrical connection element 38A of the RF chip 4) and the first coupling element 8A that may be arranged at the bottom surface 6B of the substrate 2. The first RF signal path 24A may be associated with a first RF channel of the RF chip 4. In the illustrated example, the first RF signal path 24A may extend along four arrows indicating various sections of the first RF signal path 24A.

The first RF signal path 24A may include a first section with an RF signal propagation parallel to the first main surface 6A of the substrate 2. In the illustrated example, the first section of the first RF signal path 24A may include the first SIW 36A arranged in the substrate core 32. In addition, the first RF signal path 24A may include a first planar transmission line 26A arranged on the first main surface 6A of the substrate 2. The first planar transmission line 26A may be at least partially formed in the first metal layer 12A and configured to couple the first electrical connection element 38A and the first SIW 36A. For example, the first planar transmission line 26A may include or may correspond to at least one of a microstrip line, a coplanar waveguide, a ground-signal-ground line, or the like. The first coupling element 8A may be configured to couple RF signals into or out of the first SIW 36A. In the illustrated example, the first coupling element 8A may be at least partially formed in the third metal layer 12C. For example, the first coupling element 8A may include or may correspond to one or multiple antennas, such as e.g., patch antennas.

The RF device 200 may include a second RF signal path 24B coupling a second electrical connection element 38B of the RF chip 4 and the second coupling element 8B. The second RF signal path 24B may be associated with a second RF channel of the RF chip 4 different from the first RF channel associated with the first RF signal path 24A. In the illustrated example, the second RF signal path 24B may extend along four arrows indicating various sections of the second RF signal path 24B.

The second RF signal path 24B may include a first section with an RF signal propagation parallel to the first main surface 6A of the substrate 2. In the illustrated example, the first section of the second RF signal path 24B may include the third SIW 36C arranged in the first prepreg layer 34A. In addition, the second RF signal path 24B may include a second planar transmission line 26B arranged on the first main surface 6A of the substrate 2. The second planar transmission line 26B may be at least partially formed in the first metal layer 12A and may be configured to couple the second electrical connection element 38B and the third SIW 36C. For example, the second planar transmission line 26B may include or may correspond to at least one of a microstrip line, a coplanar waveguide, a ground-signal-ground line, or the like. Furthermore, the second RF signal path 24B may include the second SIW 36B arranged in the substrate core 32. The second SIW 36B may receive RF signals from the third SIW 36B and forward these RF signals to the second coupling element 8B or vice versa. The second coupling element 8B may be similar to the first coupling element 8A as previously described.

Since the first section of the first RF signal path 24A is at least partially arranged in the substrate core 32 (see first SIW 36A), while the first section of the second RF signal path 24B is at least partially arranged in the first prepreg layer 34A above the substrate core 32 (see third SIW 36C), the first sections may be at least partially arranged on different levels with respect to the z-direction. Due to such arrangement on different levels, the first section of the first RF signal path 24A and the first section of the second RF signal path 24B may at least partially overlap or cross when viewed in the z-direction. As previously discussed in connection with the example of FIGS. 1A and 1B, such possible overlap may provide a reduced size of the RF device 200 in the x-direction and/or the y-direction.

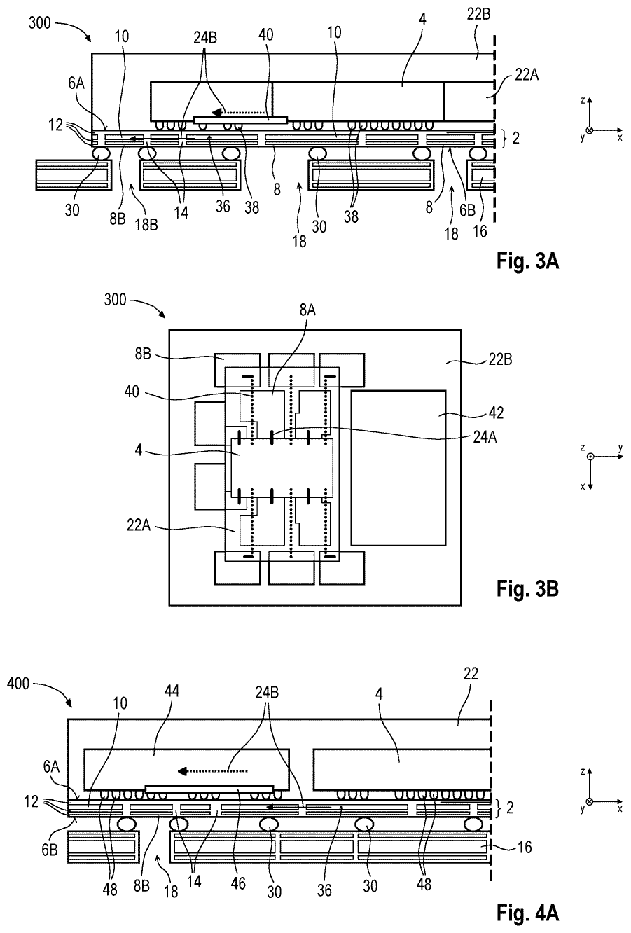

The RF device 300 of FIGS. 3A and 3B may include some or all features of previously described RF devices in accordance with the disclosure. The RF device 300 may exemplarily include two encapsulation materials 22A and 22B arranged over the first main surface 6A of the substrate 2. One or both of the encapsulation materials 22A and 22B may be similar to the encapsulation material 22 of FIGS. 1A and 1B. The first encapsulation material 22A may at least partially encapsulate the RF chip 4 and may particularly cover the side surfaces of the RF chip 4. The bottom surface of the RF chip 4 and the bottom surface of the first encapsulation material 22A may be coplanar and arranged in a common plane. The first encapsulation material 22A and the RF chip 4 embedded therein may form or may be part of a fan-out package, such as an FO-WLP (Fan-Out Wafer-Level Package) or an eWLB (embedded Wafer Level Ball Grid Array) package. The second encapsulation material 22B may at least partially encapsulate the first encapsulation material 22A and cover the top surface of the RF chip 4.

The RF device 300 may include an electrical redistribution layer 40 arranged on the bottom surface of the RF chip 4 and the bottom surface of the first encapsulation material 22A. The electrical redistribution layer 40 may be part of the fan-out package and at least partially arranged in the fan-out area of the fan-out package. The electrical redistribution layer 40 may be configured to electrically couple electrical contacts of the RF chip 4 to the electrical connection elements 38 arranged on the bottom surface of the fan-out package. In particular, the electrical redistribution layer 40 may provide an electrical redistribution between electrical contacts of the RF chip 4 and electrical connection elements 38 arranged in the fan-out area. For example, the electrical connection elements 38 may include or may correspond to copper pillars.

The RF device 300 may include a first RF signal path 24A coupling the RF chip 4 and the first coupling element 8A. The first RF signal path 24A may be associated with a first RF channel of the RF chip 4. Note that the first RF signal path 24A and the first coupling element 8A are not shown in the cross-sectional side view of FIG. 3A due to the chosen perspective. For example, the first RF signal path 24A may be similar to the first RF signal path 24A described in connection with the example of FIGS. 2A and 2B. A first section of the first RF signal path 24A may include an SIW arranged in the substrate 2 and having an RF signal propagation parallel to the main surface 6A of the substrate 2.

The RF device 300 may include a second RF signal path 24B coupling the RF chip 4 and the second coupling element 8B. The second RF signal path 24B may be associated with a second RF channel of the RF chip 4 different from the first RF channel associated with the first RF signal path 24A. In the illustrated example, the second RF signal path 24B may at least partially extend along two arrows indicating various sections of the second RF signal path 24B.

The second RF signal path 24B may include a first section having an RF signal propagation parallel to the first main surface 6A of the substrate 2. In the illustrated example, the first section of the second RF signal path 24B may include a planar transmission line that may be at least partially arranged in the electrical redistribution layer 40. For example, the planar transmission line may include or may correspond to at least one of a microstrip line, a coplanar waveguide, a ground-signal-ground line, or the like. In addition, the second RF signal path 24B may include an SIW 36 arranged in the substrate 2 which may be similar to e.g., the second SIW 36B of FIGS. 2A and 2B. For example, the planar transmission line formed in the electrical redistribution layer 40 and the SIW 26 arranged in the substrate 2 may be coupled by a galvanic connection or an antenna port feed. The SIW 36 may receive RF signals from the planar transmission line and may forward these RF signals to the second coupling element 8B or vice versa.

Since the first section of the first RF signal path 24A is at least partially arranged in the substrate 2, while the first section of the second RF signal path 24B is at least partially arranged in the electrical redistribution layer 40 above the substrate 2, the first sections may be at least partially arranged on different levels with respect to the z-direction. Due to such arrangement on different levels, the first section of the first RF signal path 24A and the first section of the second RF signal path 24B may at least partially overlap or cross when viewed in the z-direction. As previously discussed in connection with the example of FIGS. 1A and 1B, such possible overlap may provide a reduced size of the RF device 300 in the x-direction and/or the y-direction.

In some examples, the RF device 300 may include a microcontroller (or microcontroller chip) 42 configured to process signals transmitted to and/or received from the RF chip 4. For example, the microcontroller 42 may be at least partially encapsulated in the second encapsulation material 22B. In the example of FIGS. 3A and 3B, electrical connections between the microcontroller 42 and the RF chip 4 are not shown for the sake of simplicity.

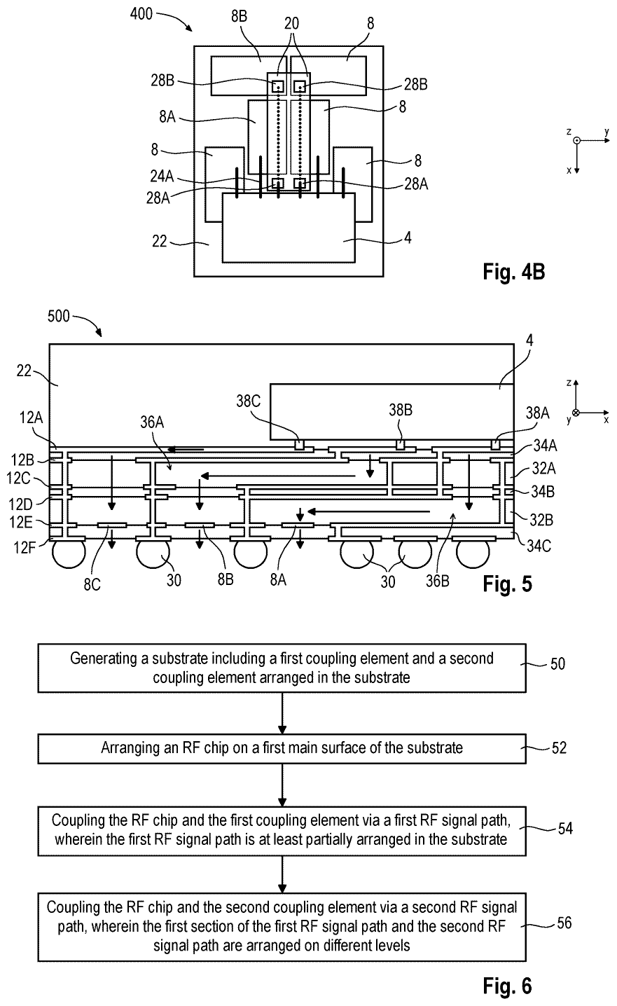

The RF device 400 of FIGS. 4A and 4B may include some or all features of previously described RF devices in accordance with the disclosure. The RF device 400 may include at least one dielectric body 44 that may be arranged on the first main surface 6A of the substrate 2. In general, the dielectric body 44 may include or may be made of any suitable dielectric material. In particular, the dielectric body 44 may include or may be made of least one of a mold compound, a low loss dielectric material, or the like. In the illustrated example, the dielectric body 44 and the RF chip 4 may be encapsulated in a same encapsulation material 22.

The dielectric body 44 may be mechanically and/or electrically connected to the substrate 2 by a plurality of connection elements 48. For example, the connection elements 48 may be configured to provide a ground potential and/or an electrical redistribution of signals e.g., outside the shown sectional plane. An electrical redistribution layer 46 may be arranged on a surface of the dielectric body 44. In the illustrated example, the electrical redistribution layer 46 may be arranged on the bottom surface of the dielectric body 44 facing the first main surface 6A of the substrate 2. Compared to conventional semiconductor packages, the dielectric body 44 does not necessarily include or contain semiconductor chips and/or other electronic components. That is, in some examples, the dielectric body 44 may exclusively consist of its dielectric material and the electrical redistribution layer 46 arranged thereon.

The RF device 400 may include a first RF signal path 24A coupling the RF chip 4 and the first coupling element 8A. The first RF signal path 24A may be associated with a first RF channel of the RF chip 4. Note that the first RF signal path 24A and the first coupling element 8A are not shown in the cross-sectional side view of FIG. 4A due to the chosen perspective. The first RF signal path 24A may be similar to any of the first RF signal paths 24A described in connection with previous examples. For example, a first section of the first RF signal path 24A may include an SIW arranged in the substrate 2.

The RF device 400 may include a second RF signal path 24B coupling the RF chip 4 and the second coupling element 8B. The second RF signal path 24B may be associated with a second RF channel of the RF chip 4 different from the first RF channel associated with the first RF signal path 24A. In the illustrated example, the second RF signal path 24B may at least partially extend along two arrows indicating various sections of the second RF signal path 24B.

The second RF signal path 24B may include a first section with an RF signal propagation parallel to the first main surface 6A of the substrate 2. In the illustrated example, the first section of the second RF signal path 24B may include a planar transmission line that may be at least partially arranged in the electrical redistribution layer 46 on the dielectric body 44. For example, the planar transmission line may include or may correspond to at least one of a microstrip line, a coplanar waveguide, a ground-signal-ground line, or the like. In addition, the second RF signal path 24B may include an SIW 36 arranged in the substrate 2 which may be similar to e.g., the second SIW 36B of FIGS. 2A and 2B. For example, an RF signal output by the RF chip 4 may be coupled into the SIW 36 and forwarded to the planar transmission line in the electrical redistribution layer 46. The planar transmission line may transmit the RF signal in a lateral direction. The RF signal may be coupled out of the substrate 2 by the second coupling element 8B. In a similar fashion, RF signals received by the second coupling element 8B may be routed to the RF chip 4 in an opposite direction.

Since the first section of the first RF signal path 24A is at least partially arranged in the substrate 2, while the first section of the second RF signal path 24B is at least partially arranged in the electrical redistribution layer 46 above the substrate 2, the first sections may be at least partially arranged on different levels with respect to the z-direction. Due to such arrangement on different levels, the first section of the first RF signal path 24A and the first section of the second RF signal path 24B may at least partially overlap or cross when viewed in the z-direction. As previously discussed in connection with the example of FIGS. 1A and 1B, such possible overlap may provide a reduced size of the RF device 400 in the x-direction and/or the y-direction.

The RF device 500 of FIG. 5 may include some or all features of previously described RF devices in accordance with the disclosure. For the sake of simplicity, FIG. 5 only shows a detail of the RF device 500. However, it is to be understood that the RF device 500 may include further components such as described in previous examples.

The substrate 2 of the RF device 500 may include an example and non-limiting number of two substrate cores 32A and 32B and three prepreg layers 34A to 34C. In the illustrated example, the first substrate core 32A may be embedded between the first prepreg layer 34A and the second prepreg layer 34B, while the second substrate core 32B may be embedded between the second prepreg layer 34B and the third prepreg layer 34C. The substrate cores 34A, 34B and the prepreg layers 34A to 34C may substantially extend in the x-y-plane and may be similar to respective components described in connection with the example of FIGS. 2A and 2B.

The substrate 2 may include a plurality of metal layers 12 that may be arranged on different levels with respect to the z-direction. In the illustrated example, the substrate 2 may include a first metal layer 12A arranged on the top surface of the first prepreg layer 34A, a second metal layer 12B arranged between the first prepreg layer 34A and the first substrate core 32A, a third metal layer 12C arranged between the first substrate core 32A and the second prepreg layer 34B, a fourth metal layer 12D arranged between the second prepreg layer 34B and the second substrate core 32B, a fifth metal layer 12E arranged between the second substrate core 32A and the third prepreg layer 34C and a sixth metal layer 12F arranged on the bottom surface of the third prepreg layer 34C. Each of the metal layers 12A to 12F may be at least partially structured.

In the illustrated example, the RF device 500 may include one or more first SIWs 36A that may be arranged in the first substrate core 32A as well as one or more second SIWs 36B that may be arranged in the second substrate core 32B. The RF device 500 may include a first signal path coupling the RF chip 4 (or more particular a first electrical connection element 38A of the RF chip 4) with a first coupling element 8A, a second RF signal path coupling the RF chip 4 (or more particular a second electrical connection element 38B of the RF chip 4) with a second coupling element 8B, and a third RF signal path coupling the RF chip 4 (or more particular a third electrical connection element 38C of the RF chip 4) with a third coupling element 8C. In the case of FIG. 5, such RF signal paths are exemplarily indicated by arrows.

As can be seen from FIG. 5, and similar to previous examples, different RF signal paths may be arranged on different levels with respect to the z-direction. Accordingly, the RF signal paths may at least partially overlap or cross when viewed in the z-direction. Such possible overlap of RF signal paths may provide a reduced size of the RF device 500 when measured in the x-direction and/or the y-direction.

FIG. 6 illustrates a flowchart of a method for manufacturing an RF device in accordance with the disclosure. The method may be used for manufacturing RF devices as previously discussed and may thus be read in connection with any of the foregoing figures. The method of FIG. 6 is described in a general manner in order to qualitatively specify aspects of the disclosure. It is to be understood that the method may include further aspects. For example, the method may be extended by any of the aspects described in connection with other examples in accordance with the disclosure.

At 50, a substrate including a first coupling element and a second coupling element arranged in the substrate may be generated. Each of the first coupling element and the second coupling element may be configured to couple RF signals into or out of the substrate. At 52, an RF chip may be arranged on a first main surface of the substrate. At 54, the RF chip and the first coupling element may be coupled via a first RF signal path. The first RF signal path may be at least partially arranged in the substrate and may include a first section with an RF signal propagation parallel to the main surface. At 56, the RF chip and the second coupling element may be coupled via a second RF signal path. The second RF signal path may include a first section with an RF signal propagation parallel to the main surface. The first section of the first RF signal path and the first section of the second RF signal path may be arranged on different levels with respect to a direction perpendicular to the first main surface of the substrate.

The description of previous examples in accordance with the disclosure mainly referred to the concept of SIWs. However, it is to be understood that this description and the aspects described therein are not limited to the concept of SIWs, but may also hold true for other waveguide types, such as air-filled waveguides. That is, in any of the previously described examples, one or more of the included SIWs may be replaced by another suitable type of waveguide.

### ASPECTS

In the following, RF devices and methods for manufacturing RF devices are explained using aspects.

Aspect 1 is an RF device, comprising: a substrate; an RF chip arranged on a first main surface of the substrate; a first coupling element arranged in the substrate and configured to couple an RF signal into or out of the substrate; a second coupling element arranged in the substrate and configured to couple an RF signal into or out of the substrate; a first RF signal path coupling the RF chip and the first coupling element, wherein the first RF signal path is at least partially arranged in the substrate and comprises a first section with an RF signal propagation parallel to the first main surface; and a second RF signal path coupling the RF chip and the second coupling element, the second RF signal path comprising a first section with an RF signal propagation parallel to the first main surface, wherein the first section of the first RF signal path and the first section of the second RF signal path are at least partially arranged on different levels with respect to a direction perpendicular to the first main surface of the substrate.

Aspect 2 is an RF device according to Aspect 1, wherein the first section of the first RF signal path and the first section of the second RF signal path at least partially overlap or cross each other when viewed in the direction perpendicular to the first main surface of the substrate.

Aspect 3 is an RF device according to Aspect 1 or 2, wherein the first section of the first RF signal path comprises a substrate integrated waveguide arranged in the substrate.

Aspect 4 is an RF device according to one of the preceding Aspects, wherein the first section of the first RF signal path comprises a planar transmission line.

Aspect 5 is an RF device according to one of the preceding Aspects, wherein the first coupling element and the second coupling element are arranged at a second main surface of the substrate opposing the first main surface.

Aspect 6 is an RF device according to one of the preceding Aspects, wherein the first section of the second RF signal path comprises a waveguide arranged on the first main surface of the substrate adjacent to the RF chip.

Aspect 7 is an RF device according to Aspect 6, wherein the second RF signal path comprises a planar transmission line arranged on the first main surface of the substrate, wherein the planar transmission line couples the waveguide arranged on the first main surface and the RF chip.

Aspect 8 is an RF device according to Aspect 6 or 7, wherein the waveguide arranged on the first main surface and the RF chip are encapsulated in a same encapsulation material.

Aspect 9 is an RF device according to one of Aspects 1 to 5, wherein: the substrate comprises a substrate core and at least one prepreg layer arranged on the substrate core, the first section of the first RF signal path comprises a waveguide arranged in the substrate core, and the first section of the second RF signal path comprises a waveguide arranged in the prepreg layer.

Aspect 10 is an RF device according to Aspect 9, wherein the second RF signal path comprises a planar transmission line comprising an electrically conductive layer arranged on the prepreg layer, wherein the planar transmission line couples the waveguide arranged in the prepreg layer and the RF chip.

Aspect 11 is an RF device according to one of Aspects 1 to 5, wherein the first section of the second RF signal path comprises a planar transmission line arranged in an electrical redistribution layer coupled to the RF chip.

Aspect 12 is an RF device according to Aspect 11, wherein the electrical redistribution layer is part of a fan-out package and arranged in a fan-out area of the fan-out package.

Aspect 13 is an RF device according to Aspect 11 or 12, wherein the first section of the second RF signal path comprises a waveguide arranged in the substrate, wherein the planar transmission line and the waveguide arranged in the substrate are coupled by a galvanic connection or an antenna port feed.

Aspect 14 is an RF device according to one of Aspects 1 to 5, further comprising: a dielectric body arranged on the first main surface of the substrate, and an electrical redistribution layer arranged on a surface of the dielectric body, wherein the first section of the second RF signal path comprises a planar transmission line arranged in the electrical redistribution layer.

Aspect 15 is an RF device according to Aspect 14, wherein the dielectric body and the RF chip are encapsulated in a same encapsulation material.

Aspect 16 is an RF device according to Aspect 14 or 15, wherein the dielectric body comprises at least one of a mold compound or a low loss dielectric material.

Aspect 17 is an RF device according to one of Aspects 1 to 5, wherein: the substrate comprises a substrate core and at least one prepreg layer arranged on the substrate core, the first section of the first RF signal path comprises a first waveguide arranged in the substrate core, and the first section of the second RF signal path comprises a second waveguide arranged in the substrate core.

Aspect 18 is an RF device according to one of the preceding Aspects, wherein the first RF signal path and the second RF signal path are associated with different RF channels of the RF chip.

Aspect 19 is an RF device according to one of the preceding Aspects, wherein the RF device comprises a PCB and a waveguide antenna, and wherein the first coupling element is configured to couple the first RF signal path via an opening of the PCB to the waveguide antenna.

Aspect 20 is a method for manufacturing an RF device, the method comprising: generating a substrate comprising a first coupling element and a second coupling element arranged in the substrate, wherein each of the first coupling element and the second coupling element is configured to couple an RF signal into or out of the substrate; arranging an RF chip on a first main surface of the substrate; coupling the RF chip and the first coupling element via a first RF signal path, wherein the first RF signal path is at least partially arranged in the substrate and comprises a first section with an RF signal propagation parallel to the first main surface; and coupling the RF chip and the second coupling element via a second RF signal path, the second RF signal path comprising a first section with an RF signal propagation parallel to the first main surface, wherein the first section of the first RF signal path and the first section of the second RF signal path are arranged on different levels with respect to a direction perpendicular to the first main surface of the substrate.

As employed in this specification, the terms “connected”, “coupled”, “electrically connected”, and/or “electrically coupled” may not necessarily mean that elements must be directly connected or coupled together. Intervening elements may be provided between the “connected”, “coupled”, “electrically connected”, or “electrically coupled” elements.

Further, the words “over” and “on” used with regard to e.g., a material layer formed or located “over” or “on” a surface of an object may be used herein to mean that the material layer may be located (e.g., formed, deposited, or the like) “directly on”, e.g., in direct contact with, the implied surface. The words “over” and “on” used with regard to e.g., a material layer formed or located “over” or “on” a surface may also be used herein to mean that the material layer may be located (e.g., formed, deposited, or the like) “indirectly on” the implied surface with e.g., one or multiple additional layers being arranged between the implied surface and the material layer.

Furthermore, to the extent that the terms “having”, “containing”, “including”, “with”, or variants thereof are used in either the detailed description or the claims, such terms are intended to be inclusive in a manner similar to the term “comprising”. That is, as used herein, the terms “having”, “containing”, “including”, “with”, “comprising”, and the like are open-ended terms that indicate the presence of stated elements or features, but do not preclude additional elements or features. The articles “a”, “an”, and “the” are intended to include the plural as well as the singular, unless the context clearly indicates otherwise.

Moreover, the words “example” and “aspect” are used herein to mean serving as an aspect, instance, or illustration. Any aspect or design described herein as “example” or “aspect” is not necessarily to be construed as advantageous over other aspects or designs. Rather, use of the words “example” and “aspect” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or multiple” unless specified otherwise or clear from context to be directed to a singular form. Also, at least one of A and B or the like generally means A or B or both A and B.

Devices and methods for manufacturing devices are described herein. Comments made in connection with a described device may also hold true for a corresponding method and vice versa. For aspect, if a specific component of a device is described, a corresponding method for manufacturing the device may include an act of providing the component in a suitable manner, even if such act is not explicitly described or illustrated in the figures.

Although the disclosure has been shown and described with respect to one or multiple implementations, equivalent alterations and modifications will occur to others skilled in the art based at least in part upon a reading and understanding of this specification and the annexed drawings. The disclosure includes all such modifications and alterations and is limited only by the concept of the following claims. In particular regard to the various functions performed by the above described components (e.g., elements, resources, or the like), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or multiple other features of the other implementations as may be desired and advantageous for any given or particular application.

1. A radio frequency (RF) device, comprising:
a substrate;
an RF chip arranged on a first main surface of the substrate;
a first coupling element arranged in the substrate and configured to couple an RF signal into or out of the substrate;
a second coupling element arranged in the substrate and configured to couple an RF signal into or out of the substrate;
a first RF signal path coupling the RF chip and the first coupling element, wherein the first RF signal path is at least partially arranged in the substrate and comprises a first section with an RF signal propagation parallel to the first main surface; and
a second RF signal path coupling the RF chip and the second coupling element, the second RF signal path comprising a first section with an RF signal propagation parallel to the first main surface,
wherein the first section of the first RF signal path and the first section of the second RF signal path are at least partially arranged on different levels of the substrate with respect to a direction perpendicular to the first main surface of the substrate.

2. The RF device of claim 1, wherein the first section of the first RF signal path and the first section of the second RF signal path at least partially overlap or cross each other when viewed in the direction perpendicular to the first main surface of the substrate.

3. The RF device of claim 1, wherein the first section of the first RF signal path comprises a substrate integrated waveguide arranged in the substrate.

4. The RF device of claim 1, wherein the first section of the first RF signal path comprises a planar transmission line.

5. The RF device of claim 1, wherein the first coupling element and the second coupling element are arranged at a second main surface of the substrate opposing the first main surface.

6. The RF device of claim 1, wherein the first section of the second RF signal path comprises a waveguide arranged on the first main surface of the substrate adjacent to the RF chip.

7. The RF device of claim 6, wherein the second RF signal path comprises a planar transmission line arranged on the first main surface of the substrate, and
wherein the planar transmission line couples the waveguide arranged on the first main surface and the RF chip.

8. The RF device of claim 6, wherein the waveguide arranged on the first main surface and the RF chip are encapsulated in a same encapsulation material.

9. The RF device of claim 1, wherein:
the substrate comprises a substrate core and at least one prepreg layer arranged on the substrate core,
the first section of the first RF signal path comprises a waveguide arranged in the substrate core, and
the first section of the second RF signal path comprises a waveguide arranged in the prepreg layer.

10. The RF device of claim 9, wherein the second RF signal path comprises a planar transmission line comprising an electrically conductive layer arranged on the prepreg layer, and
wherein the planar transmission line couples the waveguide arranged in the prepreg layer and the RF chip.

11. The RF device of claim 1, wherein the first section of the second RF signal path comprises a planar transmission line arranged in an electrical redistribution layer coupled to the RF chip.

12. The RF device of claim 11, wherein the electrical redistribution layer is part of a fan-out package and arranged in a fan-out area of the fan-out package.

13. The RF device of claim 11, wherein the first section of the second RF signal path comprises a waveguide arranged in the substrate, and
wherein the planar transmission line and the waveguide arranged in the substrate are coupled by a galvanic connection or an antenna port feed.

14. The RF device of claim 1, further comprising:
a dielectric body arranged on the first main surface of the substrate, and
an electrical redistribution layer arranged on a surface of the dielectric body, wherein the first section of the second RF signal path comprises a planar transmission line arranged in the electrical redistribution layer.

15. The RF device of claim 14, wherein the dielectric body and the RF chip are encapsulated in a same encapsulation material.

16. The RF device of claim 14, wherein the dielectric body comprises at least one of a mold compound or a low loss dielectric material.

17. The RF device of claim 1, wherein:
the substrate comprises a substrate core and at least one prepreg layer arranged on the substrate core,
the first section of the first RF signal path comprises a first waveguide arranged in the substrate core, and
the first section of the second RF signal path comprises a second waveguide arranged in the substrate core.

18. The RF device of claim 1, wherein the first RF signal path and the second RF signal path are associated with different RF channels of the RF chip.

19. The RF device of claim 1, wherein the RF device comprises a PCB and a waveguide antenna, and wherein the first coupling element is configured to couple the first RF signal path via an opening of the PCB to the waveguide antenna.

20. A method for manufacturing an RF device, the method comprising:
generating a substrate comprising a first coupling element and a second coupling element arranged in the substrate, wherein each of the first coupling element and the second coupling element is configured to couple an RF signal into or out of the substrate;
arranging an RF chip on a first main surface of the substrate;
coupling the RF chip and the first coupling element via a first RF signal path, wherein the first RF signal path is at least partially arranged in the substrate and comprises a first section with an RF signal propagation parallel to the first main surface; and
coupling the RF chip and the second coupling element via a second RF signal path, the second RF signal path comprising a first section with an RF signal propagation parallel to the first main surface, wherein the first section of the first RF signal path and the first section of the second RF signal path are arranged on different levels with respect to a direction perpendicular to the first main surface of the substrate.
